(19) United States
(12) Patent Application Publication
(10) Pub. No.: US 2016/0270597 A1
(43) Pub. Date: Sep. 22, 2016

(54) ELECTRONIC HERB GRINDER

(71) Applicant: Jonathon Walczak, Dewitt, MI (US)

(72) Inventor: Jonathon Walczak, Dewitt, MI (US)

(21) Appl. No.: 15/072,350

(22) Filed: Mar. 16, 2016

Related U.S. Application Data
(60) Provisional application No. 62/133,462, filed on Mar. 16, 2015.

(51) Int. Cl. A47J 42/56; A47J 42/16; B02C 18/08

(52) U.S. Cl. CPC A47J 42/56; B02C 18/08; A47J 42/16; A24B 7/06

(57) ABSTRACT

An apparatus for grinding herbs including one or more safety functions configured to reduce or prevent injuries.

### CROSS REFERENCE TO RELATED APPLICATIONS

This application claims the benefit of U.S. Provisional Patent Application No. 62/133,462, filed Mar. 16, 2015, and incorporated herein by reference in its entirety.

### TECHNICAL FIELD

This disclosure relates to herb processing, and more particularly to safety aspects in electronic herb grinding.

### BACKGROUND

The statements in this section merely provide background information related to the present disclosure and may not constitute prior art.

Herbs are natural products with a variety of uses, including seasoning and medicinal applications. Herb uses typically require some form of processing to render them useful. Food processors are well-known for preparing powders and slurries from nuts, stalks and the like. Grinders and shredders are known for processing dried leaves.

Known grinders, however, lack safety devices to prevent injury when operated. Therefore, there is a need for safety devices to reduce injuries to grinder operators.

### SUMMARY

An apparatus is disclosed for grinding herbs that includes one or more safety devices including in one embodiment, a kill switch configured to transition the operating state to an OFF operating state upon removal of the top cap or, alternatively, prohibit transition from an OFF operating state to an ON operating state when the top cap is disengaged from the middle section.

In one embodiment, a safety features is included for transitioning the grinder from an ON operating state to an OFF operating state upon detection of a dangerous condition such as contact by an operator to an open blade or knife.

In one embodiment, the grinder includes a variable speed control mechanism.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 is a partial cross-sectional side view of an exemplary grinder, in accordance with the present disclosure;

FIG. 2 is an exploded perspective view of a further embodiment of an exemplary grinder, in accordance with the present disclosure;

FIG. 3 is a perspective view of a top cap, in accordance with the present disclosure;

FIG. 4 is a perspective view of a middle section, in accordance with the present disclosure;

FIG. 5 is a top cross-sectional view of the housing along line B-B of FIG. 1, in accordance with the present disclosure;

FIG. 6 is a top cross-sectional side view of the housing along line A-A, in accordance with the present disclosure.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Reference will now be made to the drawings in which various elements of the present invention will be given numerical designations and in which the invention will be discussed so as to enable one skilled in the art and make use of the invention.

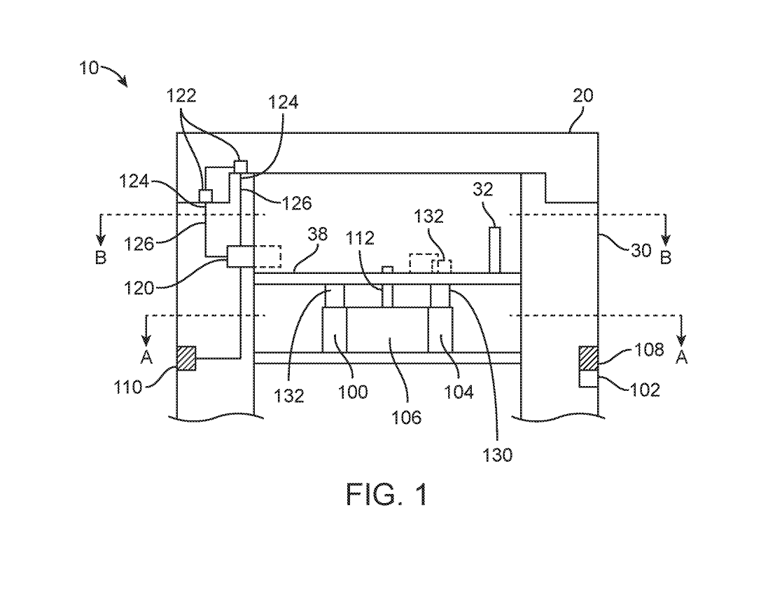

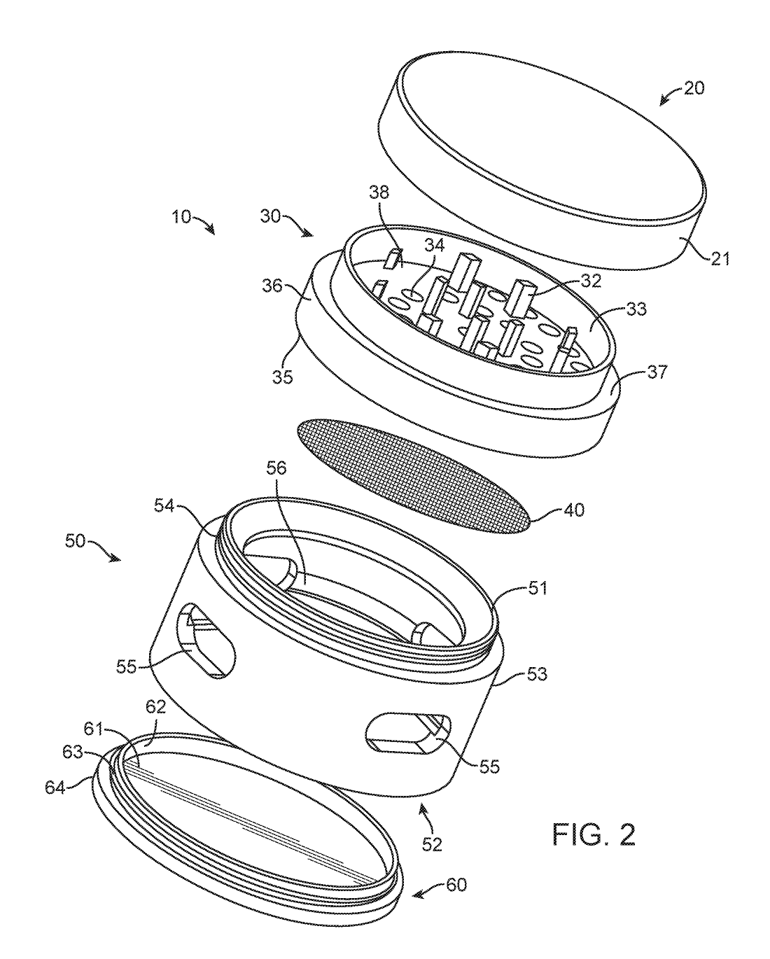

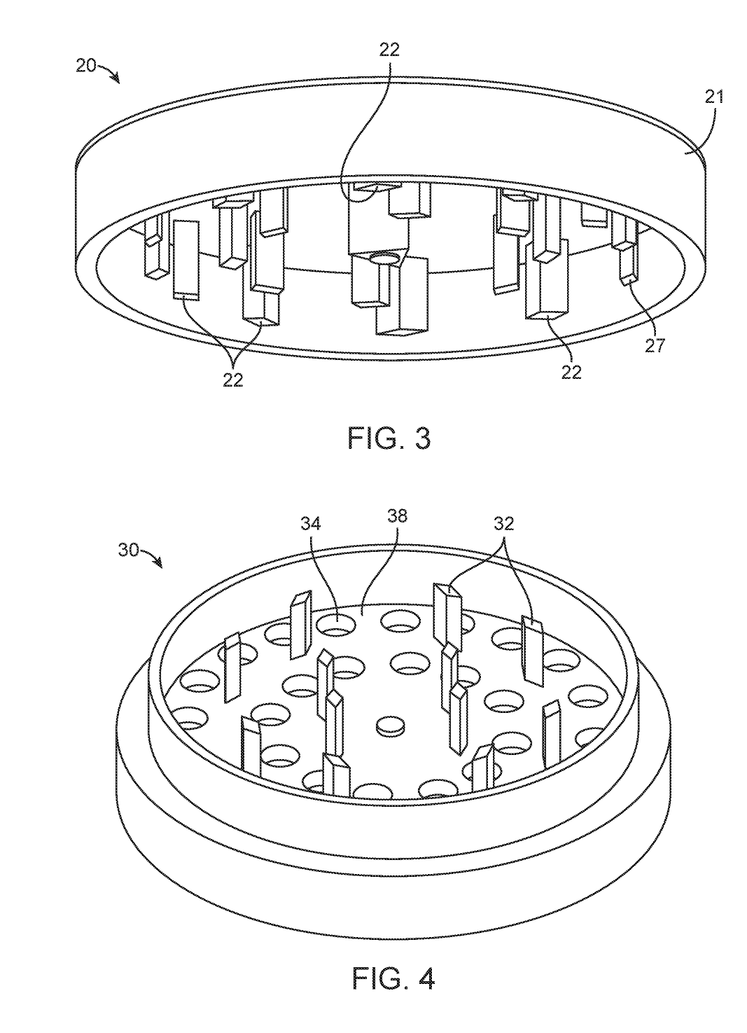

As shown in FIG. 1 and FIG. 2, the present invention comprises a grinder 10 with a top cap 20, a middle section 30, a housing 50, and a bottom cap 60. The top cap 20 is elliptical or circular in shape with a sidewall that defines its bottom opening and a top cover having a bottom face from which multiple top grinding knives 22 protrude downward, as shown in FIG. 3. It is contemplated by the disclosure herein that the teachings of the safety features may be readily applied to various embodiments of grinders having a plurality of blades.

As shown in FIG. 4, the middle section 30 is an annular object with a top opening 31 defined by a top sidewall 33 and a bottom opening 35 defined by a bottom sidewall 36. The bottom sidewall 36 has an outer diameter that is equal to the outer diameter of a sidewall 21 of the top cap 20. Whereas, the top sidewall 33 has an outer diameter that is a fraction of an inch less than the inner diameter of the sidewall 21 of the top cap 20. This dimensional configuration allows the top cap 20 to be placed directly over the top sidewall 31 of the middle section 30 and rest on an outer edge 37 a created by the bottom sidewall 36.

A circular plate 38 is permanently attached to the top sidewall 33 of the middle section 30 or formed as an integral portion thereof. In various embodiments, the outer diameter of the circular plate 38 is of sufficient size to allow it to be fit into and within the bottom sidewall 36 of the middle section 30 by force or pressure. Once in place, the circular plate 38 is permanently attached to the bottom sidewall 36 of the middle section 30 and/or the top sidewall 33. When the top cap 20 is placed over the top sidewall 31 of the middle section 30, a grinding compartment is created between the circular plate 38 and the top cap 20 and within the top sidewall 31 of the middle section 30.

The circular plate 38 has multiple holes 34 scattered at various locations to filter the content in the grinding compartment by allowing pieces smaller in size than the multiple holes to fall through and past the circular plate 38. Pieces that are larger in size than the multiple holes 34 will remain in the grinding compartment.

The circular plate 38 also has multiple bottom grinding knives 32 protruding in an upward direction. Much like the top grinding knives 22 that are permanently attached to the top cap 20, the bottom grinding knives 32 are permanently attached to the circular plate 38 in the middle section 30. Furthermore, the location of the bottom grinding knives 32 are arranged so that when the top cap 20 is placed over the top sidewall of the middle section, the bottom grinding knives do not interfere with the top grinding knives. More importantly, the location of the bottom grinding knives 32 are arranged so that when the top cap 20 is turned with respect to the middle section 30 to rotate it back and forth, the top and bottom grinding knives 22 and 32 are correspondingly moved within the grinding compartment to provide a grinding action for grinding the objects within the grinding compartment.

The housing 50 is a tubular object with a top opening 51, a bottom opening 52, and a housing sidewall 53 with an outer diameter that is the same as the outer diameter of the bottom sidewall 36 of the middle section 30. In various embodiments, the housing 50 has external threads 54 at the top and internal threads at the bottom. The housing 50 also has an internal annular edge formed at a given depth along the top of the housing sidewall 53. A screen 40 is then coupled to the internal annular edge in various embodiments.

At several locations along the housing sidewall 53 various openings 55 are placed radially to allow visual access to the interior of the housing 50. The various openings 55 can then covered with a clear plastic, such as polycarbonate or other transparent material. In various embodiments, the clear plastic is injection molded directly on to the housing 50 to permanently cover the various openings 55 completely. In one embodiment, the openings are omitted.

In one embodiment, a passageway 56 is created on the inside of the housing sidewall 53 and between each opening 55. The passageway 56 allows the clear plastic to flow between the openings 55 so that a single injection of the clear plastic is needed to cover all the openings 55. A single injection of the clear plastic is preferred because it allows all of the openings 55 to be covered by a single unbroken plastic part that cannot be removed from the housing sidewall unless it is broken into multiple pieces. A single injection of the clear plastic is also preferred because it ensures a tight seal that will keep the contents inside the housing from falling or slipping out.

The bottom cap 60 is a circular object with a bottom cover 61 and a short bottom cap sidewall 62 having external threads 63. An outside edge 64 of the bottom cap 60 can be knurled to improve the gripping surface as it is being attached to and detached from the housing 50.

In one embodiment, a grinder 10 can be operated that includes a grinder assembly such as described hereinabove, a computing device 100, i.e., a control system 100, and a device connector port 102 such as a USB port that can also function as an electrical power port in some embodiments.

The control system 100 can be any known computing device including mobile computer devices. In one embodiment, the computing device 100 may have most of the typical components of a desktop computer, including a power source, and one or more device or connection ports 102, e.g., a USB port. It will be understood that a desktop computer can also be used to power a rechargeable battery of the grinder 10. The rechargeable battery 104, which is included in the computing device 100, may be charged from an adapter and typically stores enough energy to run the laptop for two to three hours, depending on the configuration and power management of the computer. In one embodiment, the grinder includes a retractable power cord assembly 108 configured to selectively extend and retract and may be defaulted to a retract state via springs, in one embodiment.

USB is a serial bus standard with the primary goal of connecting various devices to a host computer. USB was designed to allow computer peripheral devices to be connected using a single standardized interface socket and to improve plug and play capabilities by allowing hot swapping. However, the USB also includes an important functionality of providing power to low-consumption devices, eliminating the need for an external power supply. Thus, USB can provide a 5 V supply on a single wire from which connected USB devices may draw power. The specification provides for no more than 5.25 V and no less than 4.75 V (5V±5%) between the positive and negative bus power lines. It will be understood that other portable sources of power can be utilized as well. There are several types of USB connectors capable of conducting electricity from the computing device 100 to the grinder. The connector is one of such USB connectors.

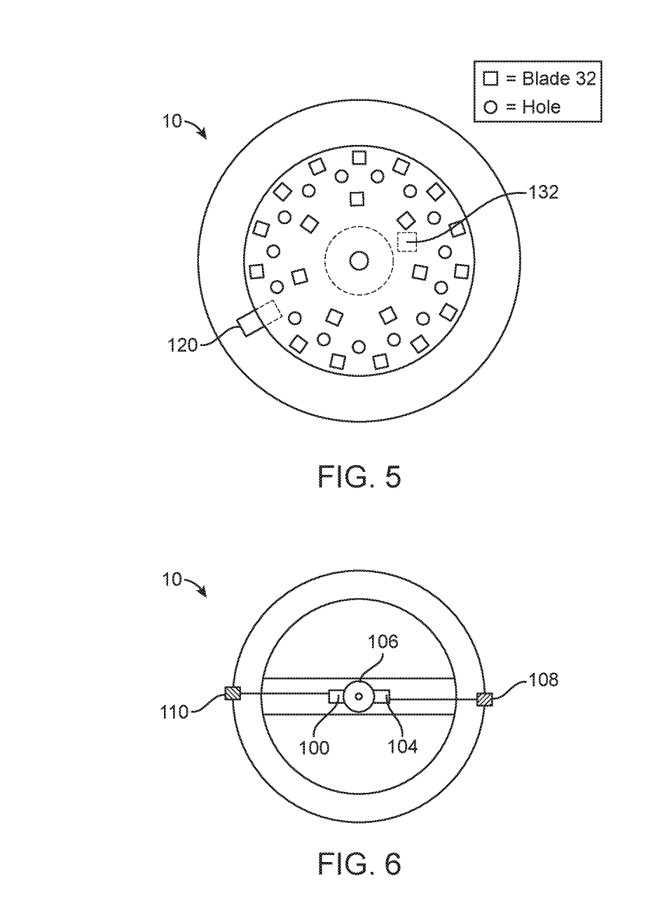

FIGS. 5 and 6 illustrate cross sectional views along lines B-B and A-A, respectively. The grinder includes a DC motor 106, a push button switch or variable control switch 110, a recharging plug, and an internal rechargeable battery. The DC motor 106 provides the power to spin the blades or knives 32 on the plate 38. The push button switch 110 is configured to switch the power ON and OFF when pressed. When pressed, the push button switch 110 causes the DC motor 106 to be started. When the button switch 110 is depressed, the DC motor 106 stops. The recharging plug 108 allows recharging of the internal rechargeable battery from an outside power source. In some example embodiments, the rechargeable plug 108 can accommodate the USB conductor. The internal rechargeable battery 104 provides the power to run the DC motor 106.

The DC motor 106 provides the power to spin the blades or knives 32 on the plate 38 via a shaft 112. The push button switch 110, when pressed, turns on the DC motor 106. When depressed, the push button switch depresses the DC motor 106. The recharging plug 108 allows recharging of the internal battery 104 from outside the casing/housing.

In some example embodiments, the grinder can include a light generated, for example, by a light-emitting diode (LED). The light can indicate the current power of the internal rechargeable battery by lighting up, for example, in green (when sufficient power) and in amber (when requires charging). The light can be activated when the push button switch is triggered. The light-emitting component can indicate the current power of the internal rechargeable battery with one or more colors according to predetermined power thresholds.

In one embodiment, the grinder 10 includes a first safety switch 120 configured to operate as a kill switch to the push button switch 110. The safety switch 120 can include conducting contact points 122 and a partial electrical circuit embedded in the top lid 20 and connected to the safety switch 120 in closed circuit only when the lid is screwed on tight thereby connecting the contact points 122 with contact points 124 of the housing 50 and a second partial circuit 126. In one embodiment, electrical conductions may be embedded that run from the push button switch 110, up the housing 50, up and down the top lid 20, back down the housing 50 and back into the push button switch 110. The safety switch 120 can prevent the DC motor 106 from running unless the top lid 20 is on and making contact.

In one embodiment, the electric herb grinder 10 can further comprise an internal rechargeable battery located outside of the grinding chamber, the internal rechargeable battery having first conductors to provide electric current to the electric motor 106, a recharging plug coupled to the grinding housing to recharge the internal rechargeable battery and having second conductors for connecting to an external power supply, thereby enabling recharging of the internal rechargeable battery, and two-condition control switch, a relay having at least one pair of openable and closable contacts, and third conductors electrically interconnecting the electric motor 106, the two-condition control switch and the relay with the internal rechargeable battery. The grinding herb grinder 10 can further comprise a driven shaft mounted and received in the grinder 10 chamber through an aperture in the spacer for rotation a grinding means mounted on the driven shaft, the grinding means being utilized to grind the herb.

In some example embodiments, the electric herb grinder 10 can include a rechargeable plug, which is connected to the external power supply via a Universal Serial Bus (USB). In some example embodiments, the electric herb grinder 10 can further comprise an external power supply, which is a portable computer providing power via a USB port and a USB cable. In some example embodiments, the electric herb grinder 10 can include a top lid of the grinding housing, wherein the top lid and the grinding housing include compatible screw threads and are attachable to each other at the separating joint by engaging the screw threads.

In some example embodiments, the electric herb grinder 10 can include the housing compartment made of plastic and the housing compartments can be snapped on thereby allowing a user to replace the internal rechargeable battery and the DC motor 106. In some example embodiments, the electric herb grinder 10 can include a blade as the grinding means. The blade can be coupled to the shaft by a screw. The grinding means can include teeth or pegs. The electric herb grinder 10 can include a Direct Current (DC) motor 106.

In some example embodiments, the electric herb grinder 10 can include a push button switch 110, pressing the push button switch results in turning on the electric motor 106, depressing the push button switch 110 results in stopping the electric motor 106. The spacer can be made of plastic. The spacer can fit rigidly on the electric motor 106 and around the shaft holding the grinding means to the shaft. In some example embodiments, the electric herb grinder 10 can further comprise a light-emitting component indicating the current power of the internal rechargeable battery with one or more colors according to predetermined power thresholds. In some example embodiments, the electric herb grinder 10 further comprises a safety switch to prevent the electric motor 106 from running when the housing compartments are not contacting each other.

Hereinafter, an explanation on the methods of opoerating and the operating states thereof will be given.

In order to use the product of the present invention, herbs are placed within the grinding compartment on top or within the bottom grinding knives. With the herbs in the grinding compartment, the top cap 20 is replaced over the middle section 30. Secondly, the top cap 20 is rotated back and forth around the middle section 30 to provide a grinding action by the top and bottom grinding knives for grinding the herbs within the grinding compartment.

A preferred mode of operation is that the user put the grinder 10 of the present invention upside down before grinding the herbs by rotating the top cap 20. After the leaves have been grinded in the grinding compartment, the user restores the position of the grinder 10 of the present invention to allow the grinded leaves to fall through the multiple holes in the circular plate 38 and into the intermediate compartment. From the intermediate compartment, the herbs pieces that have been finely grinded into the desired size will fall through the screen into the collection compartment. Thereafter, without removing any caps or opening any compartments, the user has visual access to the interior of the collection compartment through the various openings that are covered with a clear plastic. If the amount of finely grinded herbs is not sufficient, the user can then turn the grinder 10 of the present invention upside down again to allow the herbs in the intermediate compartment to fall through the multiple holes in the circular plate 38 and back into the grinding compartment for more grinding by rotating the top cap 20 back and forth. Alternatively, more herbs can be added to the grinding compartment prior to turning the grinder 10 of the present invention upside down again for more grinding. Finally, when the user can visually see through the various openings that sufficient finely grinded herbs has been produced, the user can remove the bottom cap to access the finely grinded herbs that is ready for use.

In various embodiments, the grinder 10 includes a detection subsystem of the control system that is configured to detect one or more dangerous, or triggering, conditions during use of the grinder 10. For example, the detection subsystem may be configured to detect that a portion of the user's body is dangerously close to, or in contact with, a portion of the blades or knives. In some embodiments, detection subsystem may inform the control system 100 of the dangerous condition, which then activates a reaction subsystem. In other embodiments, the detection subsystem may be adapted to activate the reaction subsystem directly.

Once activated in response to a dangerous condition, reaction subsystem is configured to engage operative structure quickly to prevent serious injury to the user. It will be appreciated that the particular action to be taken by reaction subsystem will vary depending on the type of grinder 10 and/or the dangerous condition that is detected. Further, the reaction subsystem may be configured to take a combination of steps to protect the user from serious injury. For example, reaction subsystem may be configured to do one or more of the following: stop the movement of blades, disconnect motor 106 assembly from power source, place a barrier between the grinder 10 blades and/or knives and the user, or retract the blades from its operating position, etc.

The configuration of reaction subsystem typically will vary depending on which action(s) are taken. In the exemplary embodiment, a reaction subsystem 130 is configured to stop the movement of blades and includes a brake mechanism 132, a biasing mechanism, a restraining mechanism, and a release mechanism. A brake mechanism 132 is adapted to engage the plate 38 under the urging of a biasing mechanism that is controlled by the reaction subsystem 130. During normal operation of the grinder 10, a restraining mechanism holds the brake mechanism out of engagement with the operative structure. However, upon receipt of an activation signal by the control subsystem 100, the brake mechanism 132 is released from the restraining mechanism by a release mechanism, whereupon, the brake mechanism 132 quickly engages at least a portion of the plate 38 to bring the cutting tool to a stop.

In the exemplary implementation, detection subsystem is adapted to detect the dangerous condition of the user coming into contact with blades 22 and 32. The detection subsystem includes a sensor assembly having contact detection electrodes 132, capacitively coupled to blade plate 38 and blades to detect any contact between the user's body and the blades. Typically, the blade, or some larger portion of the grinder 10, e.g., the plate 38 is electrically isolated from the remainder of the grinder 10. Alternatively, detection subsystem may include a different sensor assembly configured to detect contact in other ways, such as optically, resistively, etc. In any event, the detection subsystem is adapted to transmit a signal to the control system 100 when contact between the user and the blade is detected. The control system 100 simultaneously cuts power to the motor 106 and transmits a signal to the reaction subsystem 130 to release the brake mechanism 132.

The disclosure has described certain preferred embodiments and modifications thereto. Further modifications and alterations may occur to others upon reading and understanding the specification. Therefore, it is intended that the disclosure not be limited to the particular embodiment(s) disclosed for carrying out this disclosure, but that the disclosure will include all embodiments falling within the scope of the appended claims.

1. An electronic grinder comprising:
a grinding chamber having a plurality of grinding knives, wherein the grinding chamber is accessible through a removable cap;
a housing having an interior chamber for catching material;
a control system having one or more safety switches configured to control operation of the grinder.

2. The grinder of claim 1, wherein a first safety switch is configured to enable operation of the grinder based upon a position of the removable cap.

3. The grinder of claim 2, wherein the removable cap comprises a partial embedded electrical circuit having at least two contact points.

4. The grinder of claim 3, wherein the housing further includes a second partial embedded electrical circuit having at least two contact points.

5. The grinder of claim 4, wherein the control system is configured to detect whether the first and second partial embedded circuits comprise a closed circuit.

6. The grinder of claim 5, wherein the control system is configured to control operation of the grinder based upon whether the first and second partial embedded circuits comprise a closed circuit.

7. An electronic grinder comprising:
a grinding chamber having a plurality of grinding knives, wherein the grinding chamber is accessible through a removable cap;
a housing having an interior chamber for catching material; and
a control system having one or more safety switches configured to control operation of the grinder, wherein the control system is stored within the housing and is connected to a rechargeable battery connected to a retractable power cord.

8. The grinder of claim 7, wherein a first safety switch is configured to enable operation of the grinder based upon a position of the removable cap.

9. The grinder of claim 8, wherein the removable cap comprises a partial embedded electrical circuit having at least two contact points.

10. The grinder of claim 9, wherein the housing further includes a second partial embedded electrical circuit having at least two contact points.

11. The grinder of claim 10, wherein the control system is configured to detect whether the first and second partial embedded circuits comprise a closed circuit.

12. The grinder of claim 11, wherein the control system is configured to control operation of the grinder based upon whether the first and second partial embedded circuits comprise a closed circuit.

13. An electronic grinder comprising:
a grinding chamber having a plurality of grinding knives rotated about a circular plate, wherein the grinding chamber is accessible through a removable cap;
a housing having an interior chamber for catching grinding material;
a first safety switch configured to supply a first signal when the removable cap is engaged to the housing;
a second safety switch configured to supply a second signal when capacitance of the circular plate remains constant; and
a control system configured to allow operation of the grinder when the first and second signals are received, wherein the control system is stored within the housing and is connected to a rechargeable battery connected to a retractable power cord.

14. The grinder of claim 13, further comprising:
a safety stop or brake, actuated upon the circular stop based upon capacitance of the circular plate.

15. The grinder of claim 14, wherein the control system is configured to control operation of a motor connected to the circular plate based upon signals from the first and second safety switches.

16. The grinder of claim 15, wherein the removable cap comprises a partial embedded electrical circuit having at least two contact points.

17. The grinder of claim 16, wherein the housing further includes a second partial embedded electrical circuit having at least two contact points.

18. The grinder of claim 17, wherein the control system is configured to detect whether the first and second partial embedded circuits comprise a closed circuit.

19. The grinder of claim 18, wherein the control system is configured to control operation of the grinder based upon whether the first and second partial embedded circuits comprise a closed circuit.
